(19) United States
(12) Patent Application Publication
(10) Pub. No.: US 2025/0230857 A1
(43) Pub. Date: Jul. 17, 2025

(54) POWER TRANSMITTING MECHANISM AND DRIVING SYSTEM

(71) Applicant: Sony Interactive Entertainment Inc., Tokyo (JP)

(72) Inventors: Yuta Koda, Kanagawa (JP); Hiroshi Osawa, Kanagawa (JP)

(73) Assignee: Sony Interactive Entertainment Inc., Tokyo (JP)

(21) Appl. No.: 19/008,439

(22) Filed: Jan. 2, 2025

(30) Foreign Application Priority Data
Jan. 11, 2024 (JP) 2024-002750

(51) Int. Cl. F16H 7/12; F16H 7/08

(52) U.S. Cl. CPC F16H 7/1263; F16H 2007/0806; F16H 2007/0887

(57) ABSTRACT

Provided is a power transmitting mechanism for transmitting power from an actuator to an output shaft. The power transmitting mechanism includes a driving pulley configured to be rotated by the power, a driven pulley configured to transmit the power to the output shaft, a transmission belt stretched between the driving pulley and the driven pulley, and configured to transmit the power to the driven pulley, a biasing pulley supported so as to be movable in a direction intersecting a driving direction of the driving belt, and biased against the transmission belt, a first elastic member configured to elastically bias the biasing pulley against the transmission belt, a first additional pulley engaged with the transmission belt between the biasing pulley and the driving pulley, and a second additional pulley engaged with the transmission belt between the biasing pulley and the driven pulley.

### CROSS REFERENCE TO RELATED APPLICATION

This application claims the benefit of Japanese Priority Patent Application JP 2024-002750 filed Jan. 11, 2024, the entire contents of which are incorporated herein by reference.

### BACKGROUND

The present disclosure relates to a power transmitting mechanism and a driving system.

Japanese Patent Laid-Open No. 2014-140300 discloses a generally-called series elastic actuator (SEA) using an elastic element.

### SUMMARY

The inventor et al. of the present application are examining the possibility of accurately calculating a load torque applied to an output shaft in a power transmitting mechanism using an elastic element.

It is desirable to provide a power transmitting mechanism and a driving system that can accurately calculate a load torque applied to an output shaft.

According to an embodiment of the present disclosure, there is provided a power transmitting mechanism for transmitting power from an actuator to an output shaft. The power transmitting mechanism includes a driving pulley configured to be rotated by the power, a driven pulley configured to transmit the power to the output shaft, a transmission belt stretched between the driving pulley and the driven pulley, and configured to transmit the power to the driven pulley, a biasing pulley supported so as to be movable in a direction intersecting a driving direction of the driving belt, and biased against the transmission belt, a first elastic member configured to elastically bias the biasing pulley against the transmission belt, a first additional pulley engaged with the transmission belt between the biasing pulley and the driving pulley, and a second additional pulley engaged with the transmission belt between the biasing pulley and the driven pulley.

### BRIEF DESCRIPTION OF THE DRAWINGS

FIG. 1 is a block diagram illustrating an outline of a general configuration of a driving system according to an embodiment of the present disclosure;

FIG. 2 is a diagram illustrating an outline of a power transmitting mechanism according to an embodiment of the present disclosure;

FIG. 3 is a diagram of assistance in explaining a load torque applied to an output shaft in a case of using a tensioner in the past;

FIG. 4A is a diagram illustrating a power transmitting mechanism according to according to a modification of the present disclosure; and

FIG. 4B is a perspective view illustrating the power transmitting mechanism according to a modification of the present disclosure.

### DETAILED DESCRIPTION OF THE PREFERRED EMBODIMENT

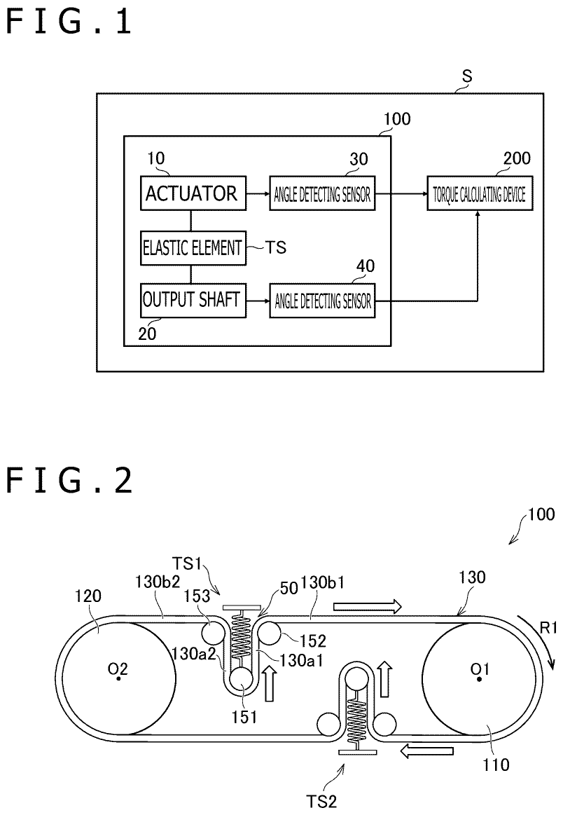

An example of a driving system S according to an embodiment of the present disclosure will hereinafter be described with reference to the drawings. FIG. 1 is a block diagram illustrating an outline of a general configuration of the driving system S according to the present embodiment. FIG. 2 is a diagram illustrating an outline of a power transmitting mechanism according to the present embodiment.

The driving system S includes a power transmitting mechanism 100 and a torque calculating device 200.

The power transmitting mechanism 100 includes an actuator 10, an output shaft 20, an angle detecting sensor 30, and an angle detecting sensor 40. The power transmitting mechanism 100 is used in an arm robot, for example. In that case, the output shaft 20 is preferably a shaft that drives an end effector.

The angle detecting sensor 30 is a sensor that detects the rotational angle of the actuator 10. The angle detecting sensor 40 is a sensor that detects the rotational angle of the output shaft 20. The angle detecting sensors 30 and 40 are preferably an encoder, for example.

The power transmitting mechanism 100 further includes an elastic element TS that generates an elastic force when the actuator 10 drives the output shaft 20. The actuator that thus transmits power via the elastic element may be referred to as an SEA.

In the power transmitting mechanism 100, the actuator 10 and the output shaft 20 are arranged so as to be separated from each other. As illustrated in FIG. 2, the power transmitting mechanism 100 further includes a driving pulley 110, a driven pulley 120, and a timing belt 130 as a transmission belt. The driving pulley 110 is rotatably supported by the actuator 10 with a rotational center O1 of the actuator 10 as a rotational center of the driving pulley 110. The driven pulley 120 is rotatably supported by the output shaft 20 with a rotational center O2 of the output shaft 20 as a rotational center of the driven pulley 120. Incidentally, the driving pulley 110 preferably rotates with a rotation of the actuator 10 and is not limited to one whose rotational center coincides with the rotational center O1 of the actuator 10. Similarly, it suffices for the driven pulley 120 to transmit power to the output shaft 20, and the driven pulley 120 is not limited to one whose rotational center coincides with the rotational center O2 of the output shaft 20.

The timing belt 130 is an annular belt that is stretched between the driving pulley 110 and the driven pulley 120, and which transmits power from the actuator 10 to the driven pulley 120. That is, the timing belt 130 is driven with a rotation of the driving pulley 110 and rotates the driven pulley 120. Gears are preferably formed on the inner circumferential surface of the timing belt 130 and the outer circumferential surfaces of the driving pulley 110 and the driven pulley 120, such that the timing belt 130, the driving pulley 110, and the driven pulley 120 are interlocked with each other with these gears in mesh with each other.

The torque calculating device 200 is a computer for calculating a load torque applied to the output shaft 20, on the basis of detection values of the angle detecting sensor 30 and the angle detecting sensor 40. The torque calculating device 200 is preferably constituted by one or a plurality of computers. The torque calculating device 200 includes at least one or more processors, a memory as at least one of a volatile memory or a nonvolatile memory, and a communication interface for wire communication or a communication interface for wireless communication. In addition, a program to be stored in the torque calculating device 200 may be supplied via a network. A reading unit (for example, a memory card slot) for reading a computer readable information storage medium or an input-output unit (for example, a USB terminal) for connection to an external apparatus, for example, may be included. In this case, the program stored on the information storage medium may be supplied via the reading unit or the input-output unit.

In the past, in a power transmitting mechanism using a timing belt, a tensioner including an elastic spring is adopted to suppress a slack and vibration of the belt. The applicant et al. of the present application are examining the possibility of calculating the load torque applied to an output shaft by using an amount of deformation of the elastic spring in the tensioner. This is because the amount of deformation of the elastic spring corresponds to a difference between the rotational angle of the actuator and the rotational angle of the output shaft, and the load torque applied to the output shaft is obtained by multiplying the deformation amount by a known spring constant. Incidentally, the rotational angle of the actuator and the rotational angle of the output shaft may be shifted from each other due to, for example, contact of the end effector with some obstacle or the like.

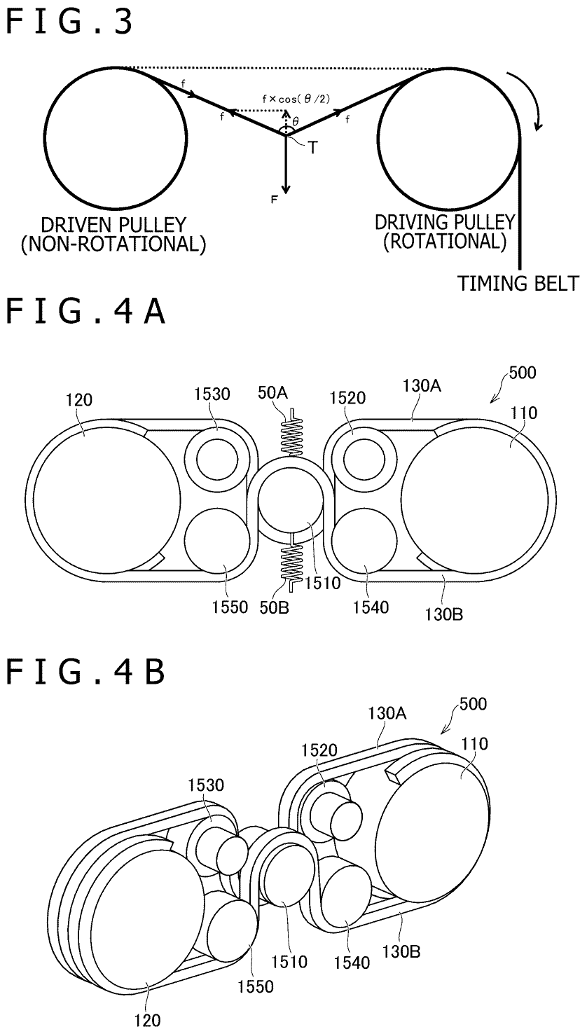

Here, with reference to FIG. 3, description will be made of the calculation of the load torque applied to the output shaft (driven pulley) in the power transmitting mechanism in the past and problems thereof. FIG. 3 is a diagram of assistance in explaining the load torque applied to the output shaft in a case where the tensioner in the past is used. Incidentally, FIG. 3 does not illustrate the tensioner (including the elastic spring).

In FIG. 3, F denotes an elastic force of the tensioner, θ denotes the angle of the timing belt bent by the tensioner abutting against the timing belt at a tension position T, and f denotes a load applied to the timing belt at the tension position T. Incidentally, here, in order to simplify the description, an example will be described in which the tensioner is in point contact at the tension position T. In actuality, however, the tension position T is preferably a region having a predetermined range. In addition, in order to simplify the description, an example will be described in which the tension position T is in the middle between a driven pulley and a driving pulley in the timing belt.

In the following, description will be made of an example in a case of calculating the load torque applied to the driven pulley when the driven pulley is made non-rotational, and the driving pulley is rotated clockwise in FIG. 3. When the driven pulley is fixed so as not to rotate and the driving pulley is rotated clockwise, the timing belt is wound by the driving pulley. Thus, the tension position T is raised while a slack is reduced, and the elastic spring of the tensioner is compressed. That is, the elastic spring of the tensioner is deformed according to a difference between the rotational angles of the driving pulley and the driven pulley. In addition, as the tension position T is raised, θ in FIG. 3 gradually increases.

In the mechanism illustrated in FIG. 3, as described above, the amount of deformation (compression amount) of the elastic spring is determined from the difference between the rotational angle of the actuator and the rotational angle of the output shaft. Therefore, the load torque applied to the output shaft (driven pulley) can be obtained on the basis of the difference between the rotational angle of the actuator and the rotational angle of the output shaft and a known spring constant of the elastic spring.

However, in a case where the tensioner in the past is adopted, the load torque applied to the output shaft nonlinearly changes according to the amount of deformation of the elastic spring, and it is thus difficult to calculate the load torque with high accuracy.

Letting k be the spring constant of the elastic spring included in the tensioner, and letting x be an amount of compression of the elastic spring, the elastic force F of the tensioner is expressed by F=kx from Hooke's law. In addition, the load f applied to the timing belt corresponds to the load torque applied to the driven pulley and is expressed by f=F/(2 cos(θ/2). Hence, the load torque f is expressed by f=kx/(2 cos (θ/2).

That is, the load torque f changes with θ and x as variables. For example, θ changes between 90° and 180° at a maximum. That is, θ/2 changes between 45° and 90° at a maximum. For example, in a case where θ changes from 120° to 150° as the driving pulley is rotated, cos(θ/2) decreases from 0.5 to approximately 0.26. Therefore, the value of 1/cos(θ/2) increases. In addition, when θ increases, the compression amount x of the elastic spring also increases. Therefore, the load torque f applied to the driven pulley increases in a manner of a quadratic curve as θ increases. In a state in which θ is close to 180°, in particular, an amount of change in the load torque f increases sharply even when an amount of increase in θ is very small. Thus, the load torque f increases in a manner of a quadratic curve (nonlinearly) according to θ, and thus the calculation of the load torque f becomes complex. In addition, even when θ changes slightly, the load torque f changes greatly. It is therefore difficult to calculate the load torque f with high accuracy.

Accordingly, the present embodiment adopts a configuration in which the load torque f is proportional to the compression amount of an elastic spring 50. Specifically, a configuration is adopted in which θ in Load Torque f=kx/(2 cos(θ/2) is 0° at all times. In a case where θ=0°,cos(θ/2)=1, and therefore the load torque f can be expressed by f=kx/2. That is, the load torque f is proportional to the compression amount of the elastic spring 50 (changes linearly).

With reference to FIG. 2, description will be made of a specific configuration for realizing θ=0°. The power transmitting mechanism 100 includes tensioners TS1 and TS2 as the elastic element TS in addition to the driving pulley 110, the driven pulley 120, and the timing belt 130 described above.

The tensioner TS1 is a mechanism that provides tension to the timing belt 130 so as to suppress slack and vibration of the timing belt 130 when the driving pulley 110 rotates in an R1 direction (clockwise direction) in FIG. 3. The tensioner T1 includes the elastic spring 50, a biasing pulley 151, and additional pulleys 152 and 153.

The elastic spring 50 elastically biases the biasing pulley 151 against the timing belt 130. One end of the elastic spring 50 (upper end in FIG. 2) is fixed. Another end of the elastic spring 50 (lower end in FIG. 2) is connected to the biasing pulley 151.

The biasing pulley 151 is supported so as to be movable in a direction intersecting (orthogonal to) the driving direction of the timing belt 130 and abuts against the outer circumferential surface of the timing belt 130. In the example illustrated in FIG. 2, when the driving pulley 110 rotates in the R1 direction, the biasing pulley 151 rises while maintaining the state of abutting against the timing belt 130. The elastic spring 50 is compressed when the biasing pulley 151 rises.

The additional pulley 152 has a gear formed on the outer circumferential surface thereof. The additional pulley 152 is disposed between the biasing pulley 151 and the driving pulley 110 so as to be engaged with the timing belt 130. The additional pulley 152 is supported so as to be rotatable with the driving of the timing belt 130. In addition, the position of the additional pulley 152 is fixed.

The additional pulley 153 has a gear formed on the outer circumferential surface thereof. The additional pulley 153 is disposed between the biasing pulley 151 and the driven pulley 120 so as to be engaged with the timing belt 130. The additional pulley 153 is supported so as to be rotatable with the driving of the timing belt 130. In addition, the position of the additional pulley 153 is fixed.

Here, in the timing belt 130, a part between the biasing pulley 151 and the additional pulley 152 is defined as a first belt portion 130a1, a part between the biasing pulley 151 and the additional pulley 153 is defined as a second belt portion 130a2, a part between the additional pulley 152 and the driving pulley 110 is defined as a third belt portion 130b1, and a part between the additional pulley 153 and the driven pulley 120 is defined as a fourth belt portion 130b2.

The additional pulley 152 and the additional pulley 153 are arranged so as to hold constant an angle between the driving direction of the first belt portion 130a1 and the driving direction of the second belt portion 130a2. Specifically, the additional pulley 152 and the additional pulley 153 are arranged such that the angle between the driving direction of the first belt portion 130a1 and the driving direction of the second belt portion 130a2 is 0°. In other words, the additional pulleys 152 and 153 are arranged such that the first belt portion 130a1 and the second belt portion 130a2 are parallel with each other.

In addition, the additional pulley 152 is disposed such that the driving direction of the first belt portion 130a1 and the driving direction of the third belt portion 130b1 are orthogonal to each other. Similarly, the additional pulley 153 is disposed such that the driving direction of the second belt portion 130a2 and the driving direction of the fourth belt portion 130b2 are orthogonal to each other.

The tensioner T2 is a mechanism that provides a tension to the timing belt 130 so as to suppress a slack of the timing belt 130 when the driving pulley 110 rotates in an opposite direction (counterclockwise direction) from the R1 direction in FIG. 3. The tensioner T2 is a similar mechanism to the tensioner T1, and therefore detailed description thereof will be omitted.

In the power transmitting mechanism 100 according to the present embodiment, because θ=0°, the load torque f expressed by f=kx/(2 cos(θ/2) and the compression amount x of the elastic spring 50 are in proportional (linear) relation to each other. It is therefore possible to calculate the load torque f by the torque calculating device 200 with case and with high accuracy.

It is to be noted that while a configuration in which the additional pulleys 152 and 153 are arranged such that θ=0° has been described in the present embodiment, there is no limitation to this. That is, a configuration may be adopted in which θ changes in a range close to 0° due to the arrangement of the additional pulleys 152 and 153.

In addition, while an example in which the tensioners T1 and T2 include the elastic spring 50 as an elastic member has been described in the present embodiment, the elastic member is not limited to a spring as long as the elastic member elastically biases the timing belt 130.

Next, a power transmitting mechanism according to a modification of the present embodiment will be described with reference to FIG. 4A and FIG. 4B. FIG. 4A is a diagram illustrating the power transmitting mechanism according to the modification. FIG. 4B is a perspective view illustrating the power transmitting mechanism according to the modification. FIG. 4B illustrates neither an elastic spring 50A nor an elastic spring 50B.

The configuration illustrated in FIG. 2 adopts a configuration provided with the two tensioners TS1 and TS2 in order to suppress a slack of the timing belt 130 in a case where the driving pulley 110 rotates in either of the clockwise direction and the counterclockwise direction. A space for arranging these tensioners is thus necessary. Therefore, the power transmitting mechanism is increased in size, which limits a range of application of the mechanism. Accordingly, the modification adopts a configuration for improving space efficiency. Specifically, a configuration using one biasing pulley 1510 is adopted.

A power transmitting mechanism 500 according to the modification includes two timing belts. Specifically, the power transmitting mechanism 500 includes a timing belt 130A and a timing belt 130B. The timing belt 130A and the timing belt 130B are separate bodies and are provided side by side in an axial direction of the driving pulley 110 so as not to be superposed on each other. The timing belt 130A is provided on a farther side of a paper plane in FIG. 4A than the timing belt 130B.

One end of the timing belt 130A is fixed to the driving pulley 110. Another end of the timing belt 130A is fixed to the driven pulley 120. One end of the timing belt 130B is fixed to the driving pulley 110. Another end of the timing belt 130B is fixed to the driven pulley 120.

In addition, the biasing pulley 1510 is provided so as to elastically bias the timing belt 130A by an elastic spring 50A. In addition, the biasing pulley 1510 is provided so as to elastically bias the timing belt 130B by an elastic spring 50B in an opposite direction from a direction in which the elastic spring 50A biases the timing belt 130A.

In addition, the power transmitting mechanism 500 includes an additional pulley 1520 engaged with the timing belt 130A between the biasing pulley 1510 and the driving pulley 110 and an additional pulley 1530 engaged with the timing belt 130A between the biasing pulley 1510 and the driven pulley 120. In addition, the power transmitting mechanism 500 includes an additional pulley 1540 engaged with the timing belt 130B between the biasing pulley 1510 and the driving pulley 110 and an additional pulley 1550 engaged with the timing belt 130B between the biasing pulley 1510 and the driven pulley 120.

Because of the configuration as described above, in the power transmitting mechanism 500, as in the power transmitting mechanism 100 illustrated in FIG. 2, the load torque and the compression amounts of the elastic springs 50A and 50B can be set in proportional (linear) relation to each other. It is therefore possible to calculate the load torque by the torque calculating device 200 with case and with high accuracy. In addition, miniaturization of the power transmitting mechanism 500 can be achieved as compared with the configuration provided with the two biasing pulleys as illustrated in FIG. 2. The power transmitting mechanism 500 is useful particularly in a case where a distance between the driving pulley 110 and the driven pulley 120 is short and the like.

### Supplementary Note

For example, the power transmitting mechanism may also be configured as follows.

(1)

A power transmitting mechanism for transmitting power from an actuator to an output shaft, the power transmitting mechanism including:
a driving pulley configured to be rotated by the power;
a driven pulley configured to transmit the power to the output shaft;
a transmission belt stretched between the driving pulley and the driven pulley, and configured to transmit the power to the driven pulley;
a biasing pulley supported so as to be movable in a direction intersecting a driving direction of the driving belt, and biased against the transmission belt;
a first elastic member configured to elastically bias the biasing pulley against the transmission belt;
a first additional pulley engaged with the transmission belt between the biasing pulley and the driving pulley; and
a second additional pulley engaged with the transmission belt between the biasing pulley and the driven pulley.
   (2)

The power transmitting mechanism according to (1), in which
the first additional pulley and the second additional pulley are arranged so as to hold constant an angle between a driving direction of a first belt portion between the biasing pulley and the first additional pulley in the transmission belt and a driving direction of a second belt portion between the biasing pulley and the second additional pulley in the transmission belt.
   (3)

The power transmitting mechanism according to (2), in which
the first additional pulley and the second additional pulley are arranged such that the first belt portion and the second belt portion are parallel with each other.
   (4)

The power transmitting mechanism according to (2) or (3), in which
the first additional pulley is disposed such that the driving direction of the first belt portion and a driving direction of a third belt portion between the first additional pulley and the driving pulley in the transmission belt are orthogonal to each other, and
the second additional pulley is disposed such that the driving direction of the second belt portion and a driving direction of a fourth belt portion between the second additional pulley and the driven pulley in the transmission belt are orthogonal to each other.
   (5)

The power transmitting mechanism according to any one of (1) to (4), in which
the transmission belt includes a first transmission belt having one end fixed to the driving pulley and having another end fixed to the driven pulley and a second transmission belt having one end fixed to the driving pulley and having another end fixed to the driven pulley and arranged side by side with the first driving belt in an axial direction of the driving pulley,
the first elastic member is disposed so as to elastically bias the biasing pulley against the first driving belt,
the first additional pulley is engaged with the first driving belt between the biasing pulley and the driving pulley,
the second additional pulley is engaged with the first driving belt between the biasing pulley and the driven pulley, and
the power transmitting mechanism includes
a second elastic member configured to elastically bias the biasing pulley against the second driving belt in an opposite direction from a direction in which the first elastic member elastically biases the biasing pulley,
a third additional pulley engaged with the second driving belt between the biasing pulley and the driving pulley, and
a fourth additional pulley engaged with the second driving belt between the biasing pulley and the driven pulley.

It should be understood by those skilled in the art that various modifications, combinations, sub-combinations and alterations may occur depending on design requirements and other factors insofar as they are within the scope of the appended claims or the equivalents thereof.

1. A power transmitting mechanism for transmitting power from an actuator to an output shaft, the power transmitting mechanism comprising:
a driving pulley configured to be rotated by the power;
a driven pulley configured to transmit the power to the output shaft;
a transmission belt stretched between the driving pulley and the driven pulley, and configured to transmit the power to the driven pulley;
a biasing pulley supported so as to be movable in a direction intersecting a driving direction of the transmission belt, and biased against the transmission belt;
a first elastic member configured to elastically bias the biasing pulley against the transmission belt;
a first additional pulley engaged with the transmission belt between the biasing pulley and the driving pulley; and
a second additional pulley engaged with the transmission belt between the biasing pulley and the driven pulley.

2. The power transmitting mechanism according to claim 1, wherein
the first additional pulley and the second additional pulley are arranged so as to hold constant an angle between a driving direction of a first belt portion between the biasing pulley and the first additional pulley in the transmission belt and a driving direction of a second belt portion between the biasing pulley and the second additional pulley in the transmission belt.

3. The power transmitting mechanism according to claim 2, wherein
the first additional pulley and the second additional pulley are arranged such that the first belt portion and the second belt portion are parallel with each other.

4. The power transmitting mechanism according to claim 2, wherein
the first additional pulley is disposed such that the driving direction of the first belt portion and a driving direction of a third belt portion between the first additional pulley and the driving pulley in the transmission belt are orthogonal to each other, and
the second additional pulley is disposed such that the driving direction of the second belt portion and a driving direction of a fourth belt portion between the second additional pulley and the driven pulley in the transmission belt are orthogonal to each other.

5. The power transmitting mechanism according to claim 1, wherein
the transmission belt includes a first transmission belt having one end fixed to the driving pulley and having another end fixed to the driven pulley and a second transmission belt having one end fixed to the driving pulley and having another end fixed to the driven pulley and arranged side by side with the first driving belt in an axial direction of the driving pulley,
the first elastic member is disposed so as to elastically bias the biasing pulley against the first driving belt,
the first additional pulley is engaged with the first driving belt between the biasing pulley and the driving pulley,
the second additional pulley is engaged with the first driving belt between the biasing pulley and the driven pulley, and
the power transmitting mechanism includes
a second elastic member configured to elastically bias the biasing pulley against the second driving belt in an opposite direction from a direction in which the first elastic member elastically biases the biasing pulley,
a third additional pulley engaged with the second driving belt between the biasing pulley and the driving pulley, and
a fourth additional pulley engaged with the second driving belt between the biasing pulley and the driven pulley.

6. A driving system comprising:
a power transmitting mechanism for transmitting power from an actuator to an output shaft, the power transmitting mechanism including
a driving pulley configured to be rotated by the power,
a driven pulley configured to transmit the power to the output shaft,
a transmission belt stretched between the driving pulley and the driven pulley, and configured to transmit the power to the driven pulley,
a biasing pulley supported so as to be movable in a direction intersecting a driving direction of the transmission belt, and biased against the transmission belt,
a first elastic member configured to elastically bias the biasing pulley against the transmission belt,
a first additional pulley engaged with the transmission belt between the biasing pulley and the driving pulley, and
a second additional pulley engaged with the transmission belt between the biasing pulley and the driven pulley; and
a torque calculating device configured to calculate a load torque applied to the output shaft, on a basis of a rotational angle of the actuator, a rotational angle of the output shaft, and a spring constant of an elastic spring included in the first elastic member.

7. The driving system according to claim 6, wherein
the first additional pulley and the second additional pulley are arranged so as to hold constant an angle between a driving direction of a first belt portion between the biasing pulley and the first additional pulley in the transmission belt and a driving direction of a second belt portion between the biasing pulley and the second additional pulley in the transmission belt.

8. The driving system according to claim 7, wherein
the first additional pulley and the second additional pulley are arranged such that the first belt portion and the second belt portion are parallel with each other.

9. The driving system according to claim 7, wherein
the first additional pulley is disposed such that the driving direction of the first belt portion and a driving direction of a third belt portion between the first additional pulley and the driving pulley in the transmission belt are orthogonal to each other, and
the second additional pulley is disposed such that the driving direction of the second belt portion and a driving direction of a fourth belt portion between the second additional pulley and the driven pulley in the transmission belt are orthogonal to each other.

10. The driving system according to claim 6, wherein
the transmission belt includes a first transmission belt having one end fixed to the driving pulley and having another end fixed to the driven pulley and a second transmission belt having one end fixed to the driving pulley and having another end fixed to the driven pulley and arranged side by side with the first driving belt in an axial direction of the driving pulley,
the first elastic member is disposed so as to elastically bias the biasing pulley against the first driving belt,
the first additional pulley is engaged with the first driving belt between the biasing pulley and the driving pulley,
the second additional pulley is engaged with the first driving belt between the biasing pulley and the driven pulley, and
the power transmitting mechanism includes
a second elastic member configured to elastically bias the biasing pulley against the second driving belt in an opposite direction from a direction in which the first elastic member elastically biases the biasing pulley,
a third additional pulley engaged with the second driving belt between the biasing pulley and the driving pulley, and
a fourth additional pulley engaged with the second driving belt between the biasing pulley and the driven pulley.
